(19) United States
(12) Patent Application Publication
(10) Pub. No.: US 2026/0299101 A1
(43) Pub. Date: Oct. 1, 2026

(54) APPARATUS AND METHOD FOR POSITIONING USING OPTICAL SIGNAL

(71) Applicants: Samsung Electronics Co., Ltd., Suwon-si (KR); INCHEON NATIONAL UNIVERSITY RESEARCH & BUSINESS FOUNDATION, Incheon (KR)

(72) Inventors: Hyeong-Ju KIM, Suwon-si (KR); Kyung Bae PARK, Suwon-si (KR); Ji-Yung LEE, Incheon (KR); Hyunchae CHUN, Incheon (KR); Jae Seong HWANG, Incheon (KR)

(73) Assignees: Samsung Electronics Co., Ltd., Suwon-si (KR); INCHEON NATIONAL UNIVERSITY RESEARCH & BUSINESS FOUNDATION, Incheon (KR)

(21) Appl. No.: 19/406,222

(22) Filed: Dec. 2, 2025

(30) Foreign Application Priority Data
Mar. 27, 2025 (KR) 10-2025-0039838

(51) Int. Cl. G01S 7/499; G01S 7/48; G01S 17/42

(52) U.S. Cl. CPC G01S 7/499; G01S 7/4802; G01S 17/42

(57) ABSTRACT

A position estimation apparatus includes a filter configured to have an attenuation ratio that varies depending on a transmission point of an optical signal and to output a second optical signal by attenuating a first optical signal emitted from a light source according to the attenuation ratio; a plurality of polarization filters configured to have different polarization directions, each of the plurality of polarization filters configured to output a corresponding third optical signal, of a plurality of third optical signals, by polarizing the second optical signal; a plurality of photoelectric devices, each of the plurality of photoelectric devices configured to convert at least one of the plurality of third optical signals into a corresponding electrical signal of a plurality of electrical signals; and a processing circuitry configured to estimate a position of the position estimation apparatus based on the plurality of electrical signals.

### CROSS-REFERENCE TO RELATED APPLICATIONS

This application claims priority under 35 U.S.C. § 119 to and the benefit of Korean Patent Application No. 10-2025-0039838 filed in the Korean Intellectual Property Office on Mar. 27, 2025, the entire contents of which are incorporated herein by reference.

### BACKGROUND

### (a) Field

The disclosure relates to an apparatus and a method for positioning using an optical signal.

### (b) Description of the Related Art

Indoor position sensing technology may be used in home, industry, and commercial fields. Devices, such as robots that make daily life convenient at home, and/or devices for indoor mobility may use position sensing technology while moving to connect and control various devices inside a smart home. In addition, indoor position sensing may be used in commercial fields to track customers and measure advertising effectiveness. For example, tracking the user's movement path and behavior patterns (e.g., based on the user's interaction with devices) may help establish and improve advertising and marketing strategies. Further, the indoor position sensing may be used for building security, such as tracking people's movement paths inside a building and monitoring the entry and exit of unauthorized people. Building security through the indoor position sensing may help keep people safe at large events and/or public spaces. Furthermore, the indoor position sensing may be used to analyze game results and players' play styles by tracking players' positions and movement paths in indoor sports. Moreover, the indoor position sensing may be used in museums and other cultural attractions to provide visitors with information about exhibitions and guide them through the space.

The Global Positioning System (GPS) may be used for position sensing, however, accuracy and/or fidelity of the position sensing with the GPS may not be sufficient to meet the demands for the indoor position sensing. Similarly, indoor position sensing using Wi-Fi may also be too inaccurate and have long recognition latency, and be difficult to use if secured Wi-Fi is used; and/or indoor position sensing using Bluetooth may be unreliable due to signal attenuation by obstacles and interference.

### SUMMARY

Some example embodiments may provide an apparatus and a method that can perform positioning using an optical signal.

According to some example embodiments, a position estimation apparatus may include a filter configured to have an attenuation ratio that varies depending on a transmission point of an optical signal and to output a second optical signal by attenuating a first optical signal emitted from a light source according to the attenuation ratio; a plurality of polarization filters configured to have different polarization directions, each of the plurality of polarization filters configured to output a corresponding third optical signal, of a plurality of third optical signals, by polarizing the second optical signal; a plurality of photoelectric devices, each of the plurality of photoelectric devices configured to convert at least one of the plurality of third optical signals into a corresponding electrical signal of a plurality of electrical signals; and a processing circuitry configured to estimate a position of the position estimation apparatus based on the plurality of electrical signals.

According to some example embodiments, a position estimation system may include a light source configured to output light; a rotating polarization filter configured to be rotate and to polarize the light output from the light source to output a first optical signal; and a position estimation apparatus comprising a filter configured to have an attenuation ratio that varies depending on a transmission point of an optical signal and to output a second optical signal by attenuating the first optical signal according to the attenuation ratio, a plurality of polarization filters configured to have different polarization directions, each of the plurality of polarization filters configured to output a corresponding third optical signal, of a plurality of third optical signals, by polarizing the second optical signal, a plurality of photoelectric devices, each of the plurality of photoelectric devices configured to convert at least one of the plurality of third optical signals into a corresponding electrical signal of a plurality of electrical signals, and a processing circuitry configured to estimate a position of the position estimation apparatus based on the plurality of electrical signals.

According to some example embodiments, a method of estimating a position of a moving apparatus may be provided. The method may include outputting a second optical signal by attenuating, with a filter, a polarized first optical signal emitted from a light source, the filter having an attenuation ratio that varies depending on a transmission point of an optical signal; outputting a plurality of third optical signals by polarizing the second optical signal using a plurality of polarization filters, the plurality of polarization filters each having different polarization directions; converting the plurality of third optical signals into a plurality of electrical signals, respectively; and estimating a positing of the moving apparatus based on the plurality of electrical signals.

### BRIEF DESCRIPTION OF THE DRAWINGS

FIG. 1 is a diagram illustrating a position estimation system according to some example embodiments.

FIG. 2 is a top view of a position estimation apparatus according to some example embodiments.

FIG. 3 is a side view of a position estimation apparatus according to some example embodiments.

FIG. 4 is a diagram illustrating a polarization filter of a position estimation apparatus according to some example embodiments.

FIG. 5 is a flowchart of a position estimation method according to some example embodiments.

FIG. 6 is a diagram illustrating a position estimation system according to some example embodiments.

FIG. 7 is a diagram illustrating electrical signals converted by a plurality of photoelectric devices of a position estimation apparatus according to some example embodiments.

FIG. 8 is a diagram illustrating averaged signals generated by a position estimation apparatus according to some example embodiments.

FIG. 9 is a diagram illustrating normalized signals generated by a position estimation apparatus according to some example embodiments.

FIG. 10 is a diagram illustrating rotation of a position estimation apparatus according to some example embodiments.

FIG. 11 is a flowchart of a position estimation method according to some example embodiments.

FIG. 12 is a diagram illustrating a process for recovering transmit data in a position estimation apparatus according to some example embodiments.

FIG. 13 is a diagram illustrating a position estimation system according to some example embodiments.

FIG. 14 is a diagram illustrating a light profile in a position estimation system according to some example embodiments.

FIG. 15, FIG. 16, FIG. 17, and FIG. 18 each are drawings illustrating an optical fingerprint map in a position estimation system according to some example embodiments.

FIG. 19 and FIG. 20 each are cross-sectional views of a photoelectric device according to some example embodiments.

FIG. 21 is a diagram illustrating a pixel structure of an organic photoelectric device according to some example embodiments.

FIG. 22 is a diagram illustrating a stacked structure of an organic photoelectric device according to some example embodiments.

FIG. 23 is a block diagram of a computing device according to some example embodiments.

### DETAILED DESCRIPTION OF THE EMBODIMENTS

In the following detailed description, only certain embodiments of the disclosure have been shown and described, simply by way of illustration. These embodiments are example embodiments. As those skilled in the art would realize, the described embodiments may be modified in various different ways, all without departing from the spirit or scope of the disclosure.

Accordingly, the drawings and description are to be regarded as illustrative in nature and not restrictive. Like reference numerals designate like elements throughout the specification. The sequence of operations or steps is not limited to the order presented in the claims or figures unless specifically indicated otherwise. The order of operations or steps may be changed, several operations or steps may be merged, a certain operation or step may be divided, and a specific operation or step may not be performed.

As used herein, the singular forms “a” and “an” are intended to include the plural forms as well, unless the context clearly indicates otherwise. Although the terms first, second, and the like may be used herein to describe various elements, components, steps, and/or operations, these terms are only used to distinguish one element, component, step, or operation from another element, component, step, or operation.

Further, “and/or” includes each of elements, components, steps, and/or operations mentioned and any combination of one or more of them.

Furthermore, the terms including ordinal numbers such as first, second, etc., may be used to describe various elements, components, steps, and/or operations, but the elements, components, steps, and/or operations are not limited by the terms. The terms are used only for the purpose of distinguishing one element, component, step, or operation from another element, component, step, or operation. For example, without departing from the range of the technology disclosed in this specification, a first element, component, step, or operation may be named a second element, component, step, or operation, and similarly, a second element, component, step, or operation may be named a first element, component, step, or operation.

Additionally, when a part of a layer, membrane, region, or plate is said to be “above” or “on” another part, this includes not only cases where it is “directly above” another part, but also cases where there is another part in-between. Conversely, when a part is said to be “right on top” or “directly on top” of another part, it means that there is no other part in-between. In the drawings, the thicknesses of each of layers or regions may be enlarged or reduced to clearly various layers or regions. Additionally, when the terms such as “about” or “substantially” are used in relation to numerical values, the relevant numerical value may be construed as including a manufacturing or operation deviation (e.g., ±10%) of the stated numerical value. In addition, when the expressions such as “generally” and “substantially” are used in relation to a geometric shape, the geometric precision may not be required, and the intention is that the degree of tolerance regarding the shape is within the scope of embodiments of the disclosure. Moreover, regardless of whether a numerical value of a shape is limited by using “about” or “substantially”, such numerical value or shape should be understood as including a manufacturing or operation deviation (e.g., ±10%) of the stated numerical value.

Also, functional unit that configured to process at least one function or operation, unless indicated otherwise, may be implemented by processing circuitry, such as hardware, software, or a combination of hardware and software. For example, the processing circuitry more specifically may include, but is not limited to, a central processing unit (CPU), an arithmetic logic unit (ALU), a digital signal processor, a microcomputer, a field programmable gate array (FPGA), a System-on-Chip (SoC), a programmable logic unit, a microprocessor, application-specific integrated circuit (ASIC), etc. The processing circuitry may include electrical components such as at least one of transistors, resistors, capacitors, etc., and/or electronic circuits including said components.

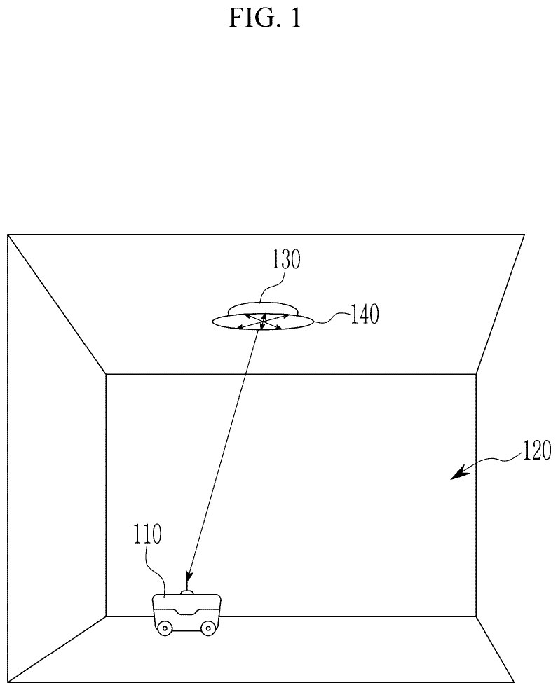

FIG. 1 is a diagram illustrating a position estimation system according to some example embodiments.

Referring to FIG. 1, a position estimation apparatus (alternatively, a positioning apparatus) 110 moving in a space (e.g., indoors) 120 may estimate a position by receiving light (e.g., an optical signal) output from a light source 130. The position estimation apparatus 110 may be a moving apparatus having mobility or an apparatus mounted on (or included with) a moving apparatus. For example, the position estimation apparatus 110 may be (and/or may be mounted onto) a robot and/or a device in a smart home. In at least one embodiment, the position estimation apparatus 110 may be mounted onto an item in order to track the movement of the item (e.g., to track user interactions with the item and/or for security). Alternatively, the position estimation apparatus 110 may be mounted onto a person (e.g., an employee (e.g., a security guard, a sales associate, etc.), player, or the like) during a monitoring period. In at least one example embodiment, the position estimated by the position estimation apparatus 110 and a corresponding time may be stored as data (e.g., in the position estimation apparatus 110 and/or a separate device (e.g., a central hub and/or server) and the data may be used to determine a trend in the position and/or movement of the position estimation apparatus 110. For example, in at least one example embodiment, the data may be applied as an input into a machine learning model configured to infer and output trends and/or patterns based on the data. Additionally, in at least one embodiment, a map of the internal space may be generated based on the data. For example, the position estimation apparatus 110 may be mounted onto a moving apparatus and/or person, and based on the areas in which the position estimation apparatus 110 has occupied and has not occupied, a map of the internal space may be generated.

The optical signal output from the light source 130 may be an electromagnetic wave in a band and intensity that will not harm (e.g., burn, blind, ionize deoxyribonucleic acid, etc.) a human body, such as visible ray, infrared, microwave, radio wave, and/or the like. The light source 130 may include, for example, a light emitting diode (LED). The position estimation apparatus 110 may convert the optical signal having at least one wavelength output from the light source 130 into an electrical signal and use the converted electrical signal to estimate the position of the moving apparatus. In at least some example embodiments, the light source 130 may be a single light source.

A rotating polarization filter 140 that polarizes the optical signal output from the light source 130 may be provided in front of the light source 130. The rotating polarization filter 140 may be rotated to polarize the optical signal output from the light source 130 to emit a polarized optical signal. The rotating polarization filter 140 may convert the optical signal with a random polarization direction (alternatively, a random polarization state or a non-polarized state) output from the light source 130 to have a polarization direction (alternatively, a polarization state) determined by a rotation angle of the rotating polarization filter 140. For example, in cases that the rotating polarization filter 140 is a linear polarization filter, the optical signal that passes through the rotating polarization filter 140 may have a polarization state that oscillates in a direction determined by the rotating polarization filter 140. Thus, the polarization direction of the polarized optical signal may vary periodically and continuously with the rotation of the rotating polarization filter 140. A rotation speed or rotation period of the rotating polarization filter 140 may be predefined.

The light source 130 and the rotating polarization filter 140 may be referred to as a transmitter, and the position estimation apparatus 110 may be referred to as a receiver.

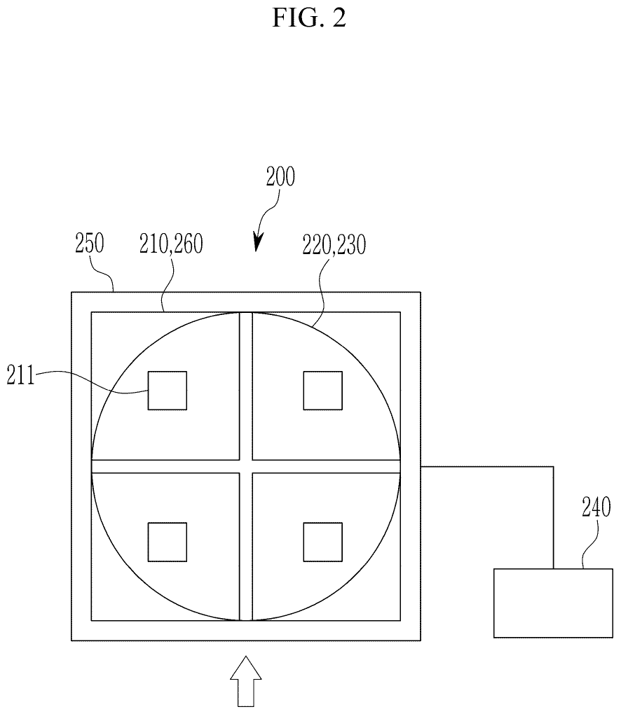

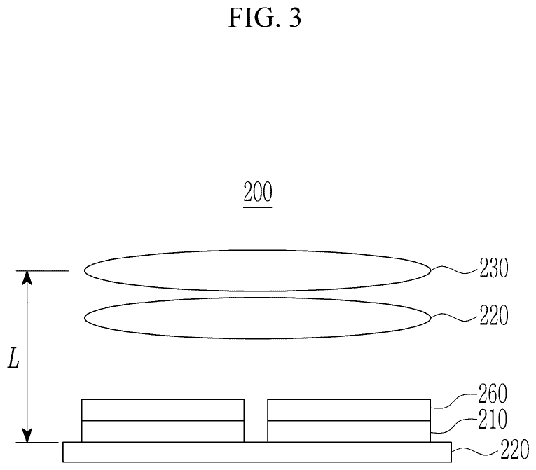

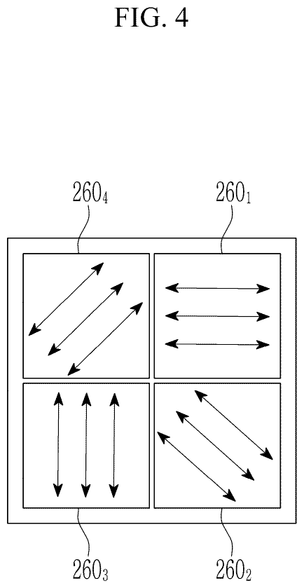

FIG. 2 is a top view of a position estimation apparatus according to some example embodiments, FIG. 3 is a side view of a position estimation apparatus according to some example embodiments, and FIG. 4 is a diagram illustrating a polarization filter of a position estimation apparatus according to some example embodiments.

Referring to FIGS. 2 and 3, a position estimation apparatus 200 may include a plurality of photoelectric devices 210, a filter 220, a lens 230, and a computing device 240. FIG. 3 is a side view of the position estimation apparatus 200, viewed from an arrow direction below in FIG. 2.

The photoelectric devices 210 may be arranged on a light-receiving surface (e.g., a flat or curved surface). For example, the position estimation apparatus 200 may be arranged on a surface of a position estimation apparatus (e.g., 110 of FIG. 1). In some example embodiments, the position estimation apparatus 200 may further include a substrate 250, and the photoelectric devices 210 may be arranged on the light-receiving surface of the substrate 250. Each photoelectric device 210 may be configured to detect an optical signal emitted by alight source (e.g., 130 in FIG. 1) and convert the detected optical signal into an electrical signal. In some example embodiments, the photoelectric devices 210 may be arranged in a two-dimensional form (e.g., in an array). In some example embodiments, the photoelectric devices 210 may be arranged symmetrical to each other on the substrate 250. In some example embodiments, four photoelectric devices 210 may be arranged in a quadrangle (2×2 array) to form a quadrant detector (QD), as shown in FIG. 2. However, this is only an example, and the number of photoelectric devices 210 may be less than and/or greater than four.

Each photoelectric device 210 may include an active zone (alternatively, an active area) 211, and the active zone 211 may detect the optical signal and generate the electrical signal depending on an intensity of the detected optical signal. The electrical signal generated by the active zone 211 may be transmitted to the computing device 240 via a channel that connects each photoelectric device 210 to the computing device 240. In some example embodiments, each photoelectric device 210 may be a photodiode (PD) or organic photodiode (OPD).

A polarization filter 260 may be disposed on each photoelectric device 210. As shown in FIG. 4, a plurality of polarization filters 260₁, 260₂, 260₃, and 260₄ may be disposed on the plurality of photoelectric devices 210, respectively, and may have different polarization directions. As the polarization filters 260₁ to 260₄ with different direction are combined with the photoelectric devices 210, respectively, the optical signal, which is polarized in one direction, from the light source 130 may be detected in different intensities by the photoelectric devices 210. Based on this, a position and an orientation angle of the position estimation apparatus 200 (e.g., a moving apparatus equipped with the position estimation apparatus 200) may be estimated. For example, in cases that the position estimation apparatus 200 uses four photoelectric devices 210 as shown in FIG. 4, the four polarization filters 260₁ to 260₄ may have a horizontal polarization (e.g., 0°), an antidiagonal polarization (e.g., 135°), a vertical polarization (e.g., 90°), and a diagonal polarization (e.g., 45°), respectively.

The lens 230 may focus the optical signal from the light source 130. In some example embodiments, the lens 230 may focus the optical signal from the light source 130 onto the photoelectric devices 210. In some example embodiments, the lens 230 may be spaced apart from the photoelectric devices 210 based on a focal length of the lens 230. In this case, a distance L between the lens 230 and the photoelectric devices 210 may be the focal length of the lens 230, or may be substantially equal to the focal length of the lens 230. For example, the distance L may represent a distance between the lens 230 and the photoelectric devices 210 opposite the lens 230, or a distance between the lens 230 and a top of the substrate 250. In cases that the distance L is the focal length of the lens 230 or substantially equal to the focal length of the lens 230, a size of an image of the light source 130 formed on the photoelectric device 210 is relatively very small, such that the light source 130 may be detected as a point light source 130 by the photoelectric device 210. In some example embodiments, the lens 230 may focus the optical signal from the light source 130 to form an image of the light source 130 on the plurality of photoelectric devices 210. In this case, the focal length of the lens 230 may be greater than zero and less than the distance L. In cases that the focus of the lens 230 is formed between the lens 230 and the photoelectric devices 210, an image having the same shape as a shape of the light source 130 may be formed on the photoelectric devices 210.

The filter 220 may be disposed between the photoelectric devices 210 and the lens 230, and may have an attenuation ratio that varies depending on a transmission point. In some example embodiments, the filter 220 may have a radial gradient pattern that attenuates the optical signal differently along direction from a center of the filter 220 to an edge of the filter 220. In some example embodiments, the filter 220 may be a neutral density (ND) filter. For example, the filter 220 may have an optical density that gradually changes along a radial direction. Hereinafter, the filter 220 is referred to as the ND filter 220. As the position estimation apparatus 200 moves, a point on the ND filter 220 at which the optical signal penetrates the ND filter 220 changes, causing a light-receiving amount of each photoelectric device 210 to change. Therefore, each position coordinate in the space has a unique characteristic with regards to the light-receiving amount by the photoelectric devices 210, allowing the position of the position estimation apparatus 200 to be estimated.

The computing device 240 may receive electrical signals through the channels connected to the photoelectric device 210, and may estimate the position of the position estimation apparatus 110 and/or the moving apparatus on which the position estimation apparatus 110 is mounted, based on the received electrical signals. In some example embodiments, processing circuitry included in the computing device 240 may perform position estimation by executing one or more instructions stored in a storage device (e.g., a memory) included in the computing device 240.

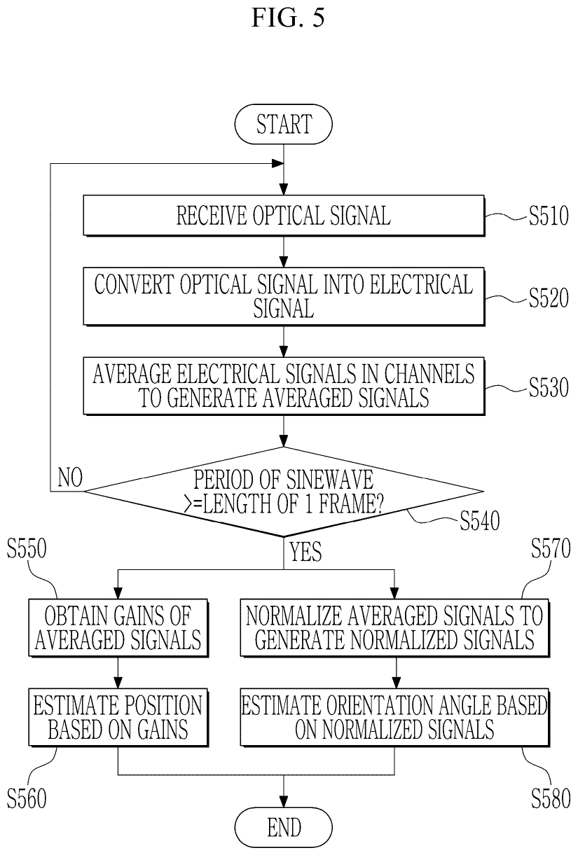

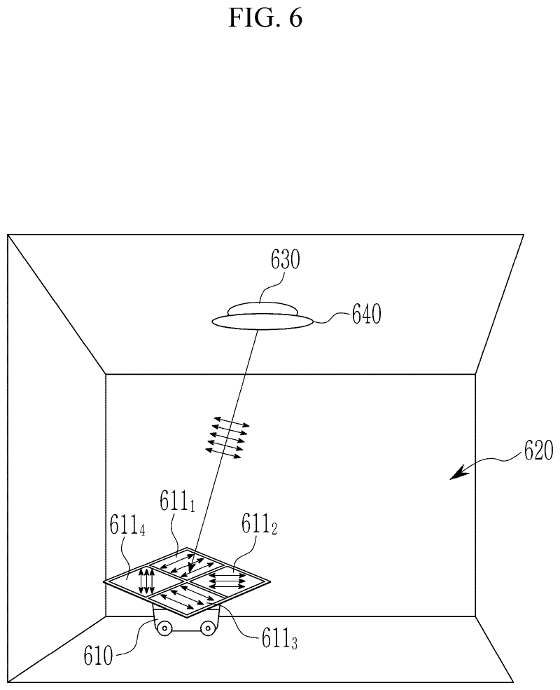

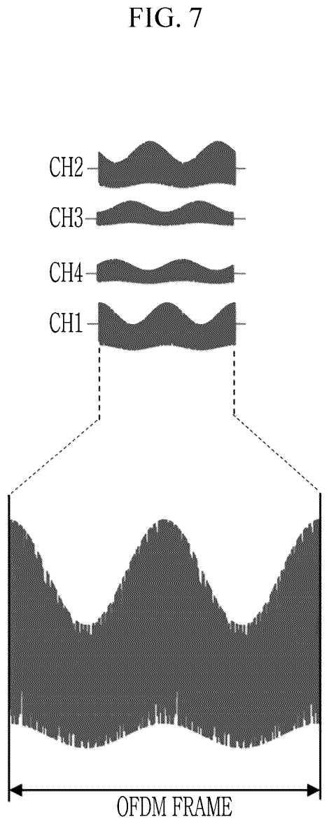

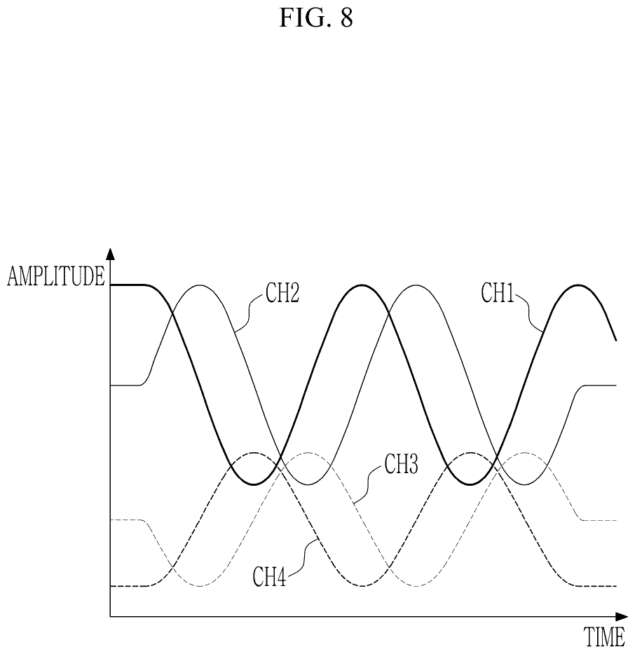

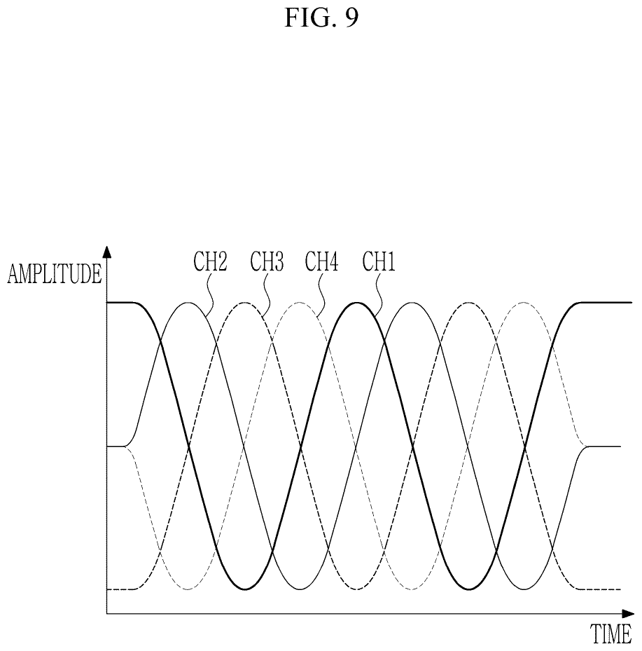

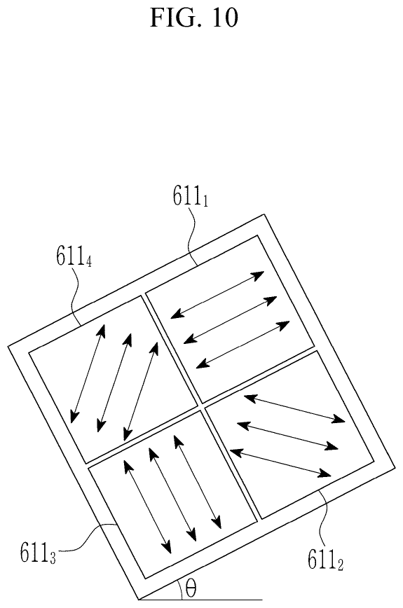

FIG. 5 is a flowchart of a position estimation method according to some example embodiments, FIG. 6 is a diagram illustrating a position estimation system according to some example embodiments, FIG. 7 is a diagram illustrating electrical signals converted by a plurality of photoelectric devices of a position estimation apparatus according to some example embodiments, FIG. 8 is a diagram illustrating averaged signals generated by a position estimation apparatus according to some example embodiments, FIG. 9 is a diagram illustrating normalized signals generated by a position estimation apparatus according to some example embodiments, and FIG. 10 is a diagram illustrating rotation of a position estimation apparatus according to some example embodiments.

Referring to FIGS. 5 and 6, a position estimation apparatus 610 may receive an optical signal transmitted from a transmitter including a light source 630 and a rotating polarization filter 640 as it moves in a space 620 (S510). The position estimation apparatus 610, the light source 630, the rotating polarization filter 640, and/or the space 620 may be the same as and/or substantially similar to the position estimation apparatus 110, the light source 130, the rotating polarization filter 140, and/or the space 120 described above, and therefore repeat descriptions thereof may be omitted for brevity. A plurality of photoelectric devices 611₁, 611₂, 611₃, and 611₄ of the position estimation apparatus 610 may convert the received optical signals into electrical signals, respectively (S520). The plurality of photoelectric devices 611₁, 611₂, 611₃, and 611₄ may be the same as or substantially similar to the plurality of photoelectric devices 210 described above, and therefore repeat descriptions thereof may be omitted for brevity. Because the optical signals that have passed through the rotating polarization filter 640 reach the photoelectric devices 611₁ to 611₄ to which polarization filters having different polarization directions are applied, the photoelectric devices 611₁ to 611₄ may detect the optical signals with different intensities and different phase patterns, as shown in FIG. 7. In other words, the photoelectric devices 611₁ to 611₄ may generate the electrical signals with different intensities and different phase patterns depending on an angle between an oscillation direction of the optical signal (e.g., provided by the light source 630 and the rotating polarization filter 640) and the polarization direction of polarization filters (e.g., 260) on the photoelectric devices 611₁ to 611₄.

The position estimation apparatus 610 may average an electrical signal from each of a plurality of channels CH1, CH2, CH3, and CH4 to generate an averaged signal for each of the plurality of channels (S530). Each of the averaged signals may be given as a sinewave. The channels CH1 to CH4 may correspond to the photoelectric devices 611₁ to 611₄, respectively, and each channel CHn may transmit the electrical signal converted (alternatively, generated, received, and/or acquired) by the corresponding photoelectric device 611ₙ. Here, n may be an integer from 1 to 4. In some example embodiments, the position estimation apparatus 610 may generate the averaged signal of each channel CHn by calculating a moving average of the electrical signal of the corresponding channel CHn, as shown in FIG. 8.

The position estimation apparatus 610 may obtain a peak-to-peak amplitude of the averaged signal of each channel CHn (S550). The peak-to-peak amplitude may be referred to as a gain. The position estimation apparatus 610 may estimate a position of the position estimation apparatus 610 based on the gains of the averaged signals of the channels CH1 to CH4 (S560). In some example embodiments, the position estimation apparatus 610 may estimate the position of the position estimation apparatus 610 by comparing the gains of the averaged signals of the plurality of channels CH1 to CH4 with a previously-generated optical fingerprint map of the space 620 (S560). The optical fingerprint map may be a map in which the space 620 are divided into a plurality of regions and a point in each of the regions is matched to a signal characteristic of each channel CHn, e.g., electrical signal converted by the photoelectric device 611ₙ. Thus, the position estimation apparatus 610 may estimate a point identified by comparing the optical fingerprint map and the gains of the averaged signals of the channels CH1 to CH4, as the position of the position estimation apparatus 610. In some example embodiments, the position estimation apparatus 610 may estimate, as the position of the position estimation apparatus 610, a point matched to the signal characteristic corresponding to the gains of the averaged signals of the channels CH1 to CH4 among signal characteristics matched to a plurality of points included in the optical fingerprint map. In some example embodiments, the optical fingerprint map may be generated based on information including a specification of the light source 630 and a specification of the position estimation apparatus 610. In some example embodiments, the specification of the light source 630 may include a maximum output power of the light source 630 and a light profile of the light source 630, and the specification of the position estimation apparatus 610 may include an attenuation ratio depending on a transmission point of an ND filter (e.g., 220 in FIG. 2).

As described above, according to some example embodiments, the position of the position estimation apparatus 610 may be estimated based on the electrical signals having different intensities from the photoelectric devices, using the filter 220 having an attenuation ratio that vary depending on the transmission point and the optical signals received through the polarization filters having the different polarization directions, thereby increasing the accuracy of the position estimation. Further, the position estimation apparatus 610 may estimate the position using a single light source 630 rather than using a plurality of light sources. Furthermore, because the position may be estimated when the position estimation apparatus 610 moves to a point where it can receive the optical signal from the light source 630, the position can be estimated over a wide area of coverage.

In some example embodiments, as shown in FIG. 9, the position estimation apparatus 610 may normalize the averaged signal of each channel CHn to generate a normalized signal of each channel CHn (S570). In some example embodiments, the position estimation apparatus 610 may normalize the averaged signals of the channels CH1 to CH4 to have the same amplitude (S570). The position estimation apparatus 610 may estimate an orientation angle of the position estimation apparatus 610 based on the normalized signals of the channels CH1 to CH4 (S580). In this case, the position estimation apparatus 610 may further reflect the estimated orientation angle upon estimating the position of the position estimation apparatus 610. That is, the position estimation apparatus 610 may estimate the position and the orientation angle based on the gains of the normalized signals of the plurality of channels CH1 to CH4 and the estimated orientation angle (S560). For example, the position estimation apparatus 610 may estimate the position based on the gains of the averaged signals of the channels CH1 to CH4 and estimate an orientation angle at the estimated position based on the estimated orientation angle.

Because the optical signals output from the filters 630 and 640 have different states of polarization (SOP) over time, the output signal (e.g., normalized signal) of each channel CHn in the position estimation apparatus 610 may also have a sine wave depending on the polarization state. In this case, because the polarization filters formed on the photoelectric devices 611₁ to 611₄ have different polarization directions, the sine waves of the output signals of the channels CH1 to CH4 may have different phase patterns. Therefore, the position estimation apparatus 610 may estimate how much the position estimation apparatus 610 has rotated (e.g., an angle by which it has rotated from a reference state) based on phase differences of the normalized signals of the plurality of channels CH1 to CH4. For example, assuming a state shown in FIG. 4 as the reference state, in cases that the position estimation apparatus 610 rotates such that the polarization filters formed on the photoelectric devices 611₁ to 611₄ are rotated by an angle θ from the reference direction (e.g., rotated by the angle θ in a counterclockwise direction), as shown in FIG. 10, the position estimation apparatus 610 may estimate the angle θ based on the phase differences of the normalized signals of the channels CH1 to CH4. In cases that the position estimation apparatus is rotated such that the orientation angle is θ, the polarization filters formed in the position estimation apparatus may also be rotated by θ. The orientation angle θ of the position estimation apparatus may be an angle with respect to the reference direction (e.g., a hypothetical x-axis direction). For example, the reference direction may be set together when a reference position (e.g., origin) of the position estimation apparatus is set.

An intensity of a current generated in the channel CHn of each photoelectric device 611ₙ may be calculated by using parameter values of the photoelectric device 611ₙ based on a relationship between the polarization filter attached to the photoelectric device 611ₙ and the incident polarized optical signal. In cases that the orientation angle of the position estimation apparatus is θ, the current Iₙ generated in the photoelectric device 611ₙ, e.g., the current Iₙ output from the n^{th} channel CHn when the linearly polarized optical signal reaches the n^{th} photoelectric device 611ₙ, may be given as shown in Equation 1.

$${I}_{n} = 0.5 RP + 0.5 RPD \cdot cos ( 2 θ - 2 {φ}_{n} ) \qquad Equation 1$$

In Equation 1, R denotes a reactivity of the photoelectric device with respect to the optical signal (0≤R≤1), P denotes an intensity (or power) of the incident optical signal, D denotes a degree of polarization (DOP) (0≤D≤1), and φₙ denotes a polarization angle (alternatively, a polarization direction) of the polarization filter attached to the photoelectric device 611ₙ corresponding to the n^{th} channel CHn. The polarization angle of the polarization filter may be determined according to the number of photoelectric devices 611₁ to 611₄. For example, in cases that there are N photoelectric devices 611₁ to 611₄, the polarization angles of N polarization filters formed on the N photoelectric devices 611₁ to 611₄ may differ by 360/N°. For example, the polarization angles of the polarization filters corresponding to the four photoelectric devices 611₁ to 611₄ may be 0°, 45°, 90°, and 135°, respectively.

Equation 1 may be expanded as Equation 2.

$$Equation 2$$

$${I}_{n} = 0.5 RP + 0.5 RPD \cdot cos ( 2 θ ) cos ( - 2 {φ}_{n} ) - 0.5 RPD \cdot sin ( 2 θ ) sin ( - 2 {φ}_{n} )$$

In cases that the position estimation apparatus 610 uses four photoelectric devices (e.g., four channels), magnitudes of currents I₁ to I₄ flowing in the four channels CH1 to CH4 may be given as shown in Equation 3, based on Equation 2.

$$I = [ \begin{matrix}{I}_{1} \\ {I}_{2} \\ {I}_{3} \\ {I}_{4}\end{matrix} ] = [ \begin{matrix}1 & cos ( 2 {φ}_{1} ) & sin ( 2 {φ}_{1} ) \\ 1 & cos ( 2 {φ}_{2} ) & sin ( 2 {φ}_{2} ) \\ 1 & cos ( 2 {φ}_{3} ) & sin ( 2 {φ}_{3} ) \\ 1 & cos ( 2 {φ}_{4} ) & sin ( 2 {φ}_{4} )\end{matrix} ] \cdot [ \begin{matrix}0.5 RP \\ 0.5 RPD \cdot cos ( 2 θ ) \\ 0.5 RPD \cdot sin ( 2 θ )\end{matrix} ] = A \cdot B \qquad Equation 3$$

In Equation 3, currents I are values measured by the position estimation apparatus, and a matrix A is a matrix with fixed values determined by the polarization angles of the polarization filters. Therefore, a matrix B, e.g., the orientation angle θ may be calculated from Equation 3. For example, the matrix B may be calculated by using a pseudo-inverse matrix as shown in Equation 4.

$$B = {( {A}^{T} A )}^{- 1} {A}^{T} I \qquad Equation 4$$

As described above, according to some example embodiments, the position estimation apparatus 610 can determine the orientation angle with respect to the reference direction based on the intensity of the current generated by the polarized optical signal from the light source 630 reaching each photoelectric device 611ₙ having the different polarizability and the polarization direction of the polarization filter located at each photoelectric device 611ₙ.

In some example embodiments, the position estimation apparatus 610 may perform the orientation angle estimation and the position estimation (S550-S580) in cases that the averaged signals of the channels CH1 to CH4 have a duration of at least one frame (S540). Here, one frame may correspond to one rotation of the rotating polarization filter 640 provided to the light source 630.

In some example embodiments, a computing device (e.g., 240 in FIG. 2) of the position estimation apparatus 610, particularly processing circuitry of the computing device 240, may perform the operations S530 to S590.

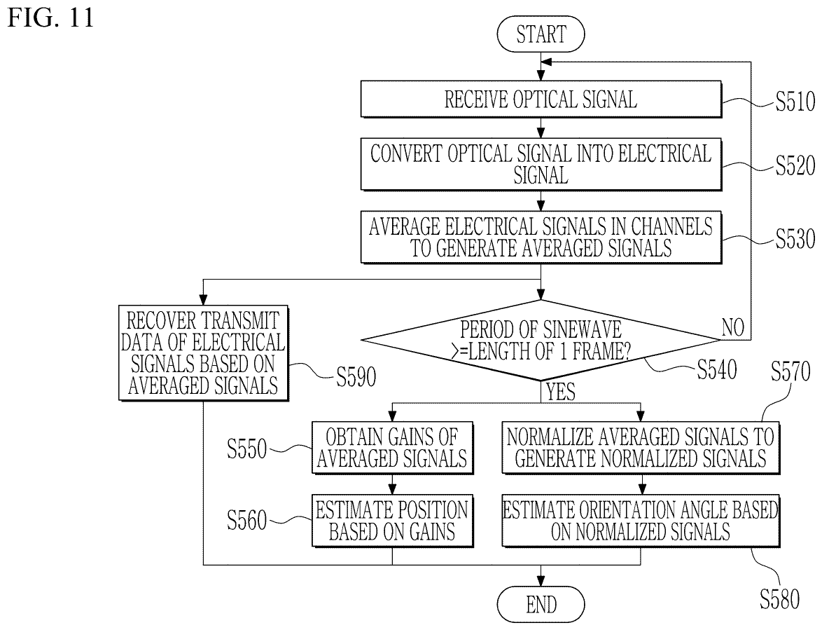

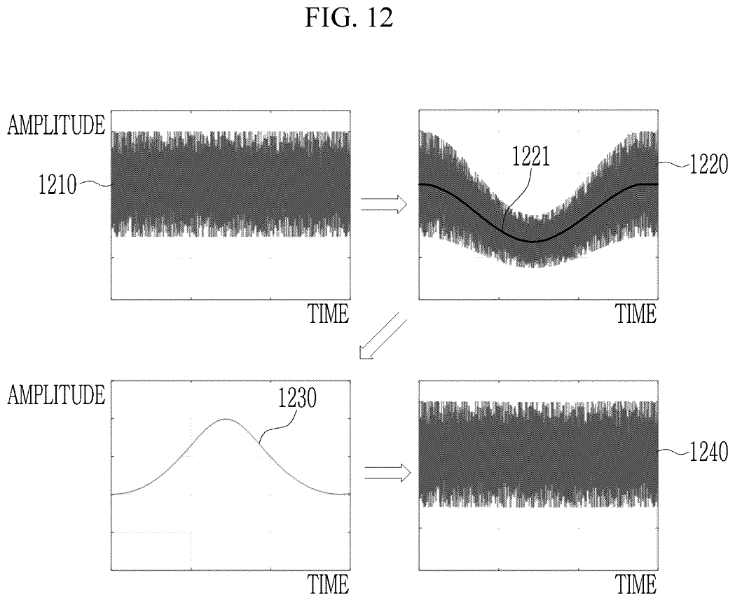

FIG. 11 is a flowchart of a position estimation method according to some example embodiments, and FIG. 12 is a diagram illustrating a process for recovering transmit data in a position estimation apparatus according to some example embodiments.

Referring to FIGS. 6 and 11, a light source 630 may modulate transmit data and output an optical signal including the modulated transmit data through a rotating polarization filter 640. For example, as shown in FIG. 7, the optical signal including the transmit data may have a pattern modulated according to a modulation scheme for the transmit data. In some example embodiments, orthogonal frequency-division multiplexing (OFDM) may be used as the modulation scheme for the transmit data.

The position estimation apparatus 610 may recover the transmit data (S590) along with the position estimation (S510 to S580). Referring to FIG. 12, a raw optical signal (e.g., OFDM signal) 1210 output from a transmitter (e.g., a light source 630) may be distorted by polarizations of the rotating polarization filter 640 and polarization filters of the position estimation apparatus 610, and then be received by the position estimation apparatus 610. An electrical signal (alternatively, a received signal) 1220 generated by converting the optical signal in the position estimation apparatus 610 may have a form of the OFDM signal combined with a sine wave due to the polarizations. For example, a response distorted by the rotation of the rotating polarization filter 640 and the polarization filter disposed on each photoelectric device 611ₙ may be given as Equation 5.

$$Response = 1 + \frac{cos ( 2 π {f}_{R} + {θ}_{est} + {θ}_{OPD} ) - 1}{2} \times D \qquad Equation 5$$

In Equation 5, D denotes a degree of polarization (DOP), f_{R} denotes a rotation frequency of the rotating polarization filter 640, θₑₛₜ denotes an estimated orientation angle of the position estimation apparatus 610, and θ_{OPD} denotes a polarization angle of the polarization filter formed on the photoelectric device 611ₙ. D may be a value between 0 and 1, and may be one (e.g., 100%) for completely blocking orthogonal polarization and zero (e.g., 0%) for completely passing the orthogonal polarization.

Because an averaged signal 1221 generated in the position estimation process S530 of the position estimation apparatus 610 corresponds to the sine wave that represents the distorted response, the position estimation apparatus 610 may invert the averaged signal 1221 of each channel CHn and remove the distortion of the received signal 1220 of the corresponding channel CHn based on the inverted signal 1230. In some example embodiments, the position estimation apparatus 610 may remove the distortion by multiplying the received signal 1220 of each channel CHn by the inverted signal 1230 of the corresponding channel CHn, and therefore, recover the raw optical signal (e.g., transmit data) 1240.

As described above, in some example embodiments, the position estimation apparatus can recover the transmit data transmitted from the light source. Thus, the position estimation apparatus can be used for data communication in addition to the position estimation.

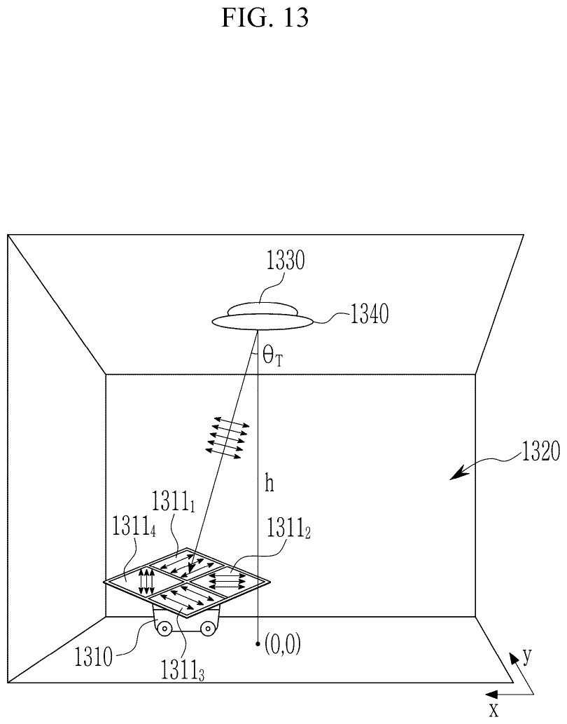

Next, an optical fingerprint map according to some example embodiments is described with reference to FIGS. 13 to 18.

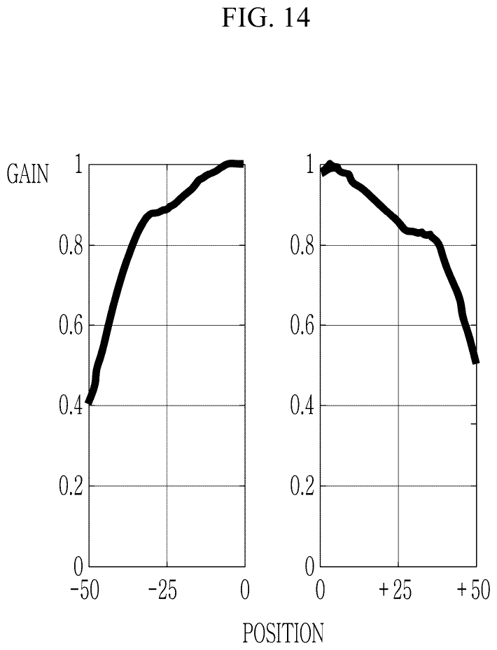

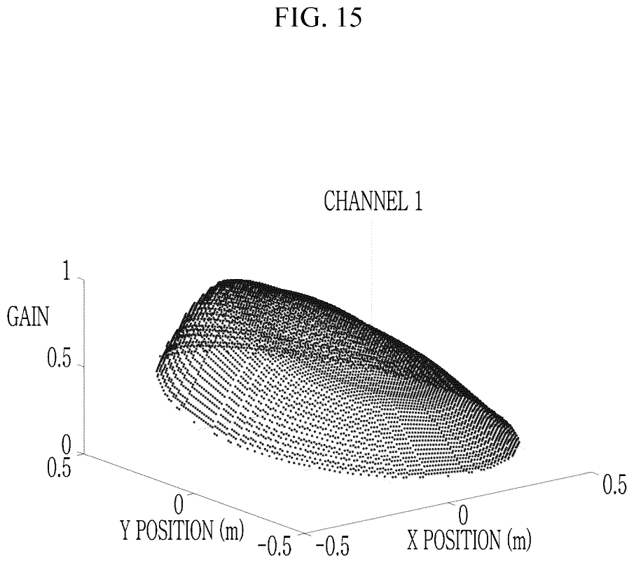

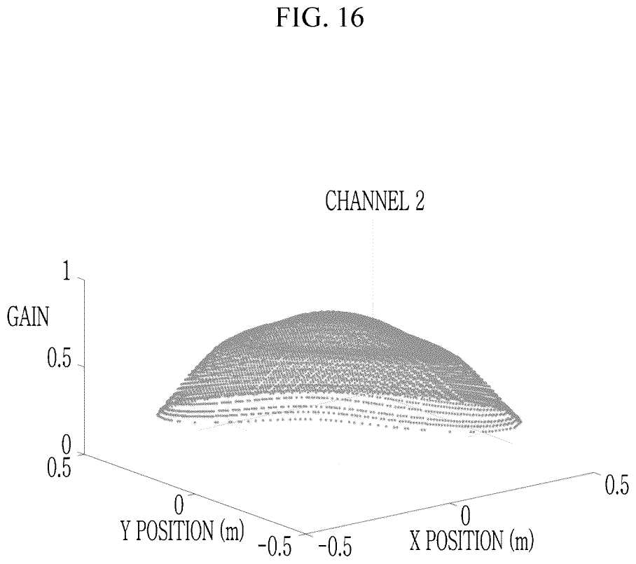

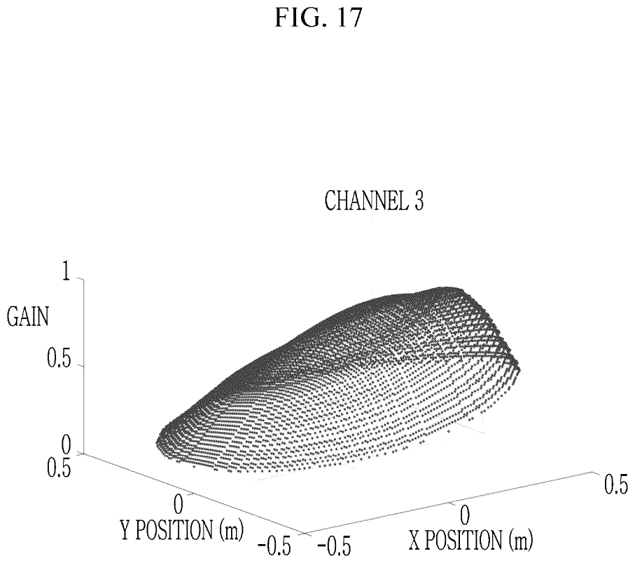

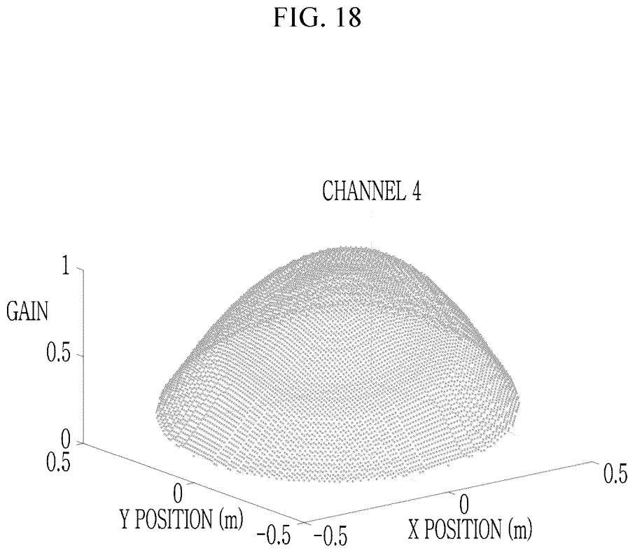

FIG. 13 is a diagram illustrating a position estimation system according to some example embodiments, FIG. 14 is a diagram illustrating a light profile in a position estimation system according to some example embodiments, and FIG. 15, FIG. 16, FIG. 17, and FIG. 18 each are drawings illustrating an optical fingerprint map in a position estimation system according to some example embodiments.

Referring to FIG. 13, a position estimation apparatus 1310 may generate an optical fingerprint map by partitioning a space (e.g., indoor space) 1320 into a plurality of regions (e.g., grids) and calculating an intensity of a light power at a point in each region based on information including a specification of a light source 1330 and a specification of the position estimation apparatus 1310.

For example, an ideal light power (intensity of an optical signal) at a receiving point in the space 1320 may be calculated as shown in Equation 6.

$${P}_{L a m b} = \frac{{P}_{max} \times ( m + 1 ) ( cos {θ}_{T}^{m + 1} ) cos {θ}_{R}}{2 π {d}_{n}^{2}} \qquad Equation 6$$

In Equation 6, P_{Lamb} denotes an ideal light power at the receiving point, Pₘₐₓ denotes a maximum output power of the light source 1330, m denotes a Lambertian order determined by a Lambertian distribution of the light source 1330, and θ_{T} denotes an emission angle of an optical signal from the light source 1330, θ_{R} denotes a reception angle of the optical signal from the light source 1330 at the receiving point, and dₙ denotes a distance between the light source 1330 and an n^{th} photoelectric device 1311ₙ of a plurality of photoelectric devices 1311₁, 1311₂, 1311₃, and 1311₄ of the position estimation apparatus 1310. For example, as shown in FIG. 13, in cases that the light source 1330 is disposed on the ceiling of the indoor space 1320 and the position estimation apparatus 1310 moves on the floor of the indoor space 1320, the emission angle θ_{T} and the reception angle θ_{R} of the light source 1330 may be the same. The maximum output power Pₘₐₓ of the light source 1330 may be provided by the specification of the light source 1330. The distance dₙ may be determined based on information including coordinates (x,y) of the position estimation apparatus 1310, a position of the n^{th} photoelectric device 1311ⁿ in the position estimation apparatus 1310, and a height h of the space 1320.

Reflecting attenuation due to an ND filter (e.g., 220 in FIG. 2) of the position estimation apparatus 1310 and an actual power distribution of the light source 1330 into the ideal light power P_{Lamb}, a light power Pₘₐₚ of the optical signal received by the position estimation apparatus 1310 at coordinates (x,y) of a particular point may be calculated as shown in Equation 7. The light power Pₘₐₚ may correspond to an intensity of an electrical signal generated by the photoelectric device.

$${P}_{m a p} = {P}_{L a m b} \times {ρ}_{ND} ( x , y ) \times {γ}_{LED} ( x , y ) \qquad Equation 7$$

In Equation 7, ρ_{ND} denotes a function that calculates an attenuation ratio depending on a transmission point in the ND filter 220, and γ_{LED} denotes a light profile of the light source 1330.

In some example embodiments, an optical density of the ND filter 220 may increase from a center to an edge. For example, the optical density may be 0.04 at the center and 1.0 at the edge. The attenuation ratio ρ_{ND} of the ND filter 220 may be determined on a per-photoelectric device basis. In some example embodiments, in cases that an active zone of each photoelectric device 1311ₙ receives the optical signal at coordinates (x,y) of the position estimation apparatus 1310, the position estimation apparatus 1310 may calculate the transmission point of the ND filter 220, and calculate the attenuation ratio ρ_{ND} of the ND filter 220 applied to the photoelectric device 1311ₙ based on the transmission point of the ND filter 220.

In some example embodiments, the light profile of the light source 1330 may be provided by the specification of the light source 1330. In some example embodiments, the light profile of the light source 1330 may be measured directly by a lux meter. The light profile of the light source 1330 may be given, for example, as shown in FIG. 14. In FIG. 14, a position represents an x coordinate that varies from −50 centimeters (cm) to 50 cm in cases that a point on the floor corresponding to the center of the light source 1330 is set to an origin and a y coordinate is fixed at zero. The light profile shown in FIG. 14 shows a gain of a power measured at each position in cases that a gain of a power measured at the origin is normalized to one. As shown in FIG. 14, the light profile (e.g., the normalized power gain) may decrease with distance from the origin.

In some example embodiments, the light power Pₘₐₚ of each channel may be determined based on the light profile described with reference to FIG. 14, the attenuation ratio of the ND filter 220, and the ideal light power of the light source 1330. The ideal light power may be determined based on the maximum output power of the light source 1330, the Lambertian distribution of the light source 1330, the emission angle of the light source 1330, and the distance between the photoelectric device and the light source 1330 in the corresponding channel. In cases that the position estimation apparatus 1310 moves in a two-dimensional plane corresponding to the floor of the space 1320, the light power of each channel may be given, for example, as shown in FIGS. 15 to 18. In FIGS. 15 to 18, an origin is a point on the floor corresponding to the center of the light source 1330, and a gain is a peak-to-peak amplitude of the light power (e.g., electrical signal generated by the photoelectric device) normalized to one.

The position estimation apparatus 1310 may generate an optical fingerprint map based on the light power of each channel as shown in FIGS. 15 to 18 and store it in a memory. The position estimation apparatus 1310 may compare gains of averaged signals of the plurality of channels measured during actual movement with the optical fingerprint map, find a position where the gains of the averaged signals of the channels and the light powers of the channels stored in the optical fingerprint map are most similar, and estimate that position as the position of the position estimation apparatus 1310.

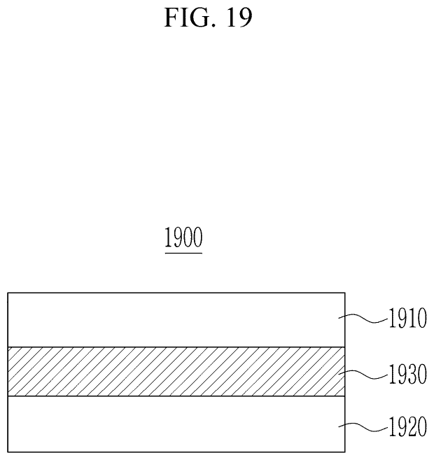

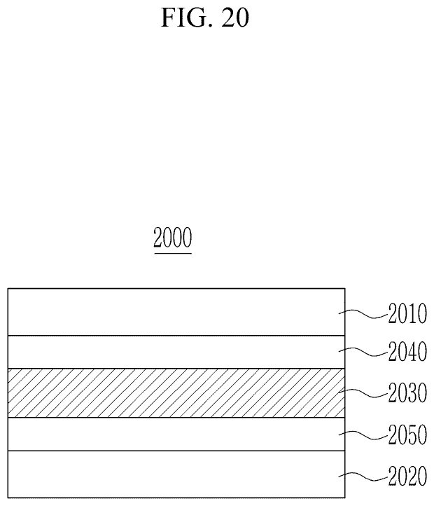

FIG. 19 and FIG. 20 each are cross-sectional views of a photoelectric device according to some example embodiments.

Referring to FIG. 19, a photoelectric device 1900 may be an organic photoelectric device. The organic photoelectric device 1900 may include a first electrode 1910 and a second electrode 1920 facing each other, and an active layer 1930 disposed between the first electrode 1910 and the second electrode 1920.

One of the first electrode 1910 and the second electrode 1920 may be an anode and the other may be a cathode. At least one of the first electrode 1910 and the second electrode 1920 may be a light transmitting electrode. The light transmitting electrode may be formed of, for example, a transparent conductor such as indium tin oxide (ITO) or indium zinc oxide (IZO), or a thin single or multiple layers of metal film. One of the first electrode 1910 and the second electrode 1920 may be a non-light transmitting electrode, and the opaque electrode may be formed of an opaque conductor such as aluminum (Al). For example, both the first electrode 1910 and the second electrode 1920 may be light transmitting electrodes.

The active layer 1930 may include a p-type semiconductor and an n-type semiconductor, and a p-n junction may be formed in the active layer 1930. The p-n junction may be a bulk heterojunction including a mixture of p-type material and n-type material, or a planar heterojunction in which p-type material and n-type material are stacked, respectively. Light transmitted the from outside of the organic photoelectric device 1900 may generate excitons in the active layer 1930, and the generated excitons may be separated into holes and electrons in the active layer 1930.

The active layer 1930 may include a compound as a p-type semiconductor or an n-type semiconductor. The compound may be a light absorber that selectively absorbs light of a predetermined wavelength band in a visible light band. For example, the compound may selectively absorb light in a green wavelength band. For example, the compound may have a maximum absorption wavelength λₘₐₓ between about 500 nanometers (nm) and 600 nm, and an energy bandgap of about 2.0 electron volts (eV) to 2.5 eV.

Referring to FIG. 20, an organic photoelectric device 2000 may include a first electrode 2010 and a second electrode 2020 facing each other, and an active layer 2030 disposed between the first electrode 2010 and the second electrode 2020. In some example embodiments, the organic photoelectric device may further include a charge auxiliary layer 2040 between the first electrode 2010 and the active layer 2030, and a charge auxiliary layer 2050 between the second electrode 2020 and the active layer 2030. The charge auxiliary layers 2040 and 2050 may facilitate the movement of charge carriers (e.g., holes and electrons) separated from the active layer 2030 to increase efficiency.

The charge auxiliary layers 2040 and 2050 may include at least one of a hole injecting layer (HIL) that facilitates injection of holes, a hole transporting layer (HTL) that facilitates transport of holes, an electron blocking layer (EBL) that blocks movement of electrons, an electron injecting layer (EIL) that facilitates injection of electrons, an electron transporting layer (ETL) that facilitates transport of electrons, or an electron blocking layer (EBL) that blocks movement of holes.

The charge auxiliary layers 2040 and 2050 may include, for example, at least one of an organic material, an inorganic material, and/or an organic-inorganic material. The organic material may be an organic compound having hole or electronic properties, and the inorganic material may be, for example, a metal oxide such as molybdenum oxide, tungsten oxide, or nickel oxide.

The hole transporting layer may include, for example, at least one selected from poly(3,4-ethylenedioxythiophene):poly(styrenesulfonate) (PEDOT:PSS), polyan arylamine, poly(N-vinylcarbazole), polyaniline, polypyrrole, N,N,N′,N′-tetrakis(4-methoxyphenyl)-benzidine (TPD), 4-bis[N-(1-naphthyl)-N-phenyl-amino]biphenyl (α-NPD), m-MTDATA, 4,4′,4″-tris(N-carbazolyl)-triphenylamine (TCTA), and/or a combination thereof.

The electron blocking layer may include, for example, at least one selected from (poly(3,4-ethylenedioxythiophene):poly(styrenesulfonate) (PEDOT:PSS), polyarylamine, poly(N-vinylcarbazole), polyaniline, polypyrrole, N,N,N′,N′-tetrakis(4-methoxyphenyl)-benzidine (TPD), 4-bis[N-(1-naphthyl)-N-phenyl-amino]biphenyl (α-NPD), 4,4′,4″-Tris(N-3-methylphenyl-N-phenyl-amino) triphenylamine (m-MTDATA), 4,4′,4″-tris(N-carbazolyl)-triphenylamine (TCTA), and/or a combination thereof.

The electron transporting layer may include, for example, at least one selected from 1,4,5,8-naphthalene-tetracarboxylic dianhydride (NTCDA), bathocuproine (BCP), LiF, Alq3, Gaq3, Inq3, Znq2, Zn(BTZ)2, BeBq2, and/or a combination thereof.

The hole blocking layer may include, for example, at least one selected from 1,4,5,8-naphthalene-tetracarboxylic dianhydride (NTCDA), bassocuproine (BCP), LiF, Alq3, Gaq3, Inq3, Znq2, Zn(BTZ)2, BeBq2, and/or a combination thereof.

In some example embodiments, one of the charge auxiliary layers 2040 and 2050 may be omitted.

The organic photoelectric device may be applied to a solar cell, an image sensor, photodetectors, a light sensor, and an organic photo diode (OPD), but is not limited thereto.

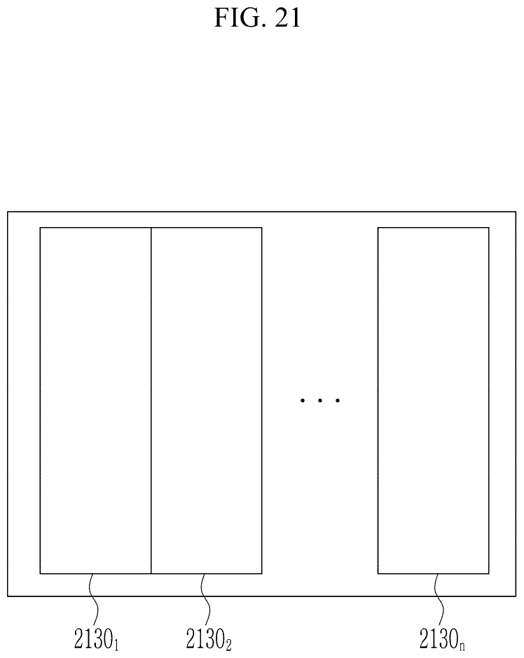

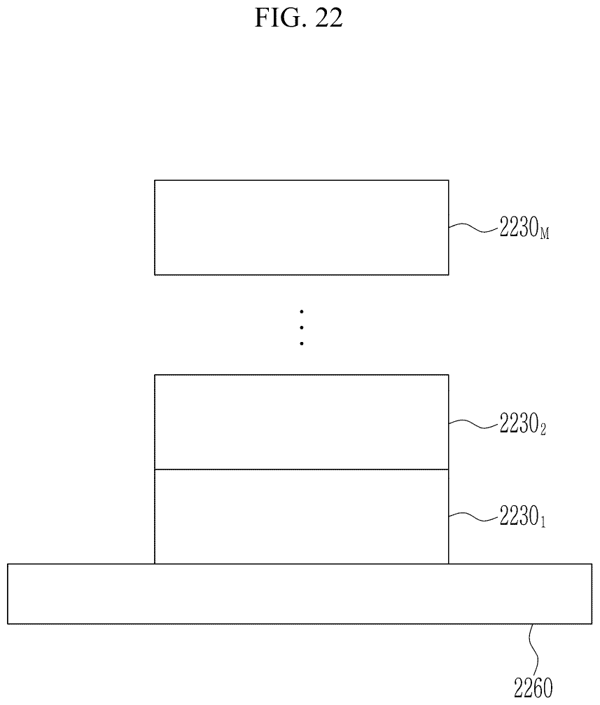

FIG. 21 is a diagram illustrating a pixel structure of an organic photoelectric device according to some example embodiments, and FIG. 22 is a diagram illustrating a stacked structure of an organic photoelectric device according to some example embodiments.

An organic photoelectric device shown in FIGS. 21 and 22 may convert optical signals having different wavelength bands into electrical signals sequentially or simultaneously. In cases that an optical signal in a first wavelength band and an optical signal in a second wavelength band are received sequentially, the organic photoelectric device may generate an electrical signal corresponding to each optical signal through a cell or active layer corresponding to each wavelength band. Alternatively, in cases that the optical signal in the first wavelength band and the optical signal in the second wavelength band reach the position estimation apparatus simultaneously, the organic photoelectric device may generate electrical signals corresponding to the respective optical signals through cells or active layers corresponding to the respective wavelength bands. In other words, the photoelectric conversion ability of the organic photoelectric device may be determined according to the wavelength bans corresponding to the cell or active layer included in the organic photoelectric device.

Referring to FIG. 21, a photoelectric device may include a plurality of cells pixelated on a substrate. The photoelectric device may be an organic photoelectric device, including an organic active layer. For example, each cell in the organic photoelectric device may include a plurality of active layers 2130₁ to 2130_{M} arranged in a two-dimensional array structure, and the active layers 2130₁ to 2130_{M} may correspond to different wavelength bands.

For example, among the active layers 2130₁ to 2130_{M} in each cell, a first active layer 2130₁ may correspond to an infrared band, a second active layer 2130₂ may correspond to a red light band, a third active layer 2130₃ may correspond to a green light band, a fourth active layer 2130₄ may correspond to a blue light band, and a fifth active layer 2130₅ may correspond to a near ultraviolet band. Each cell may include all of the first to fifth active layers 2130₁ to 2130₅, or only some of the first to fifth active layers 2130₁ to 2130₅.

For example, in cases that each cell of the organic photoelectric device includes the second active layer 2130₂, the third active layer 2130₃, and the fourth active layer 2130₄, the organic photoelectric device may convert all optical signals in the visible light band into electrical signals. Alternatively, in cases that each cell of the organic photoelectric device includes only the first active layer 2130₁ and the third active layer 2130₃, the organic photoelectric device may convert optical signals in the infrared band and the green light band into electrical signals. In at least one example embodiment, an averaged signal may be produced per each of the optical bands, and/or based on a combination of the optical bands.

Referring to FIG. 22, an organic photoelectric device may include a plurality of cells pixelated on a substrate 2260. Each cell in the organic photoelectric device may include a plurality of active layers 2230₁ to 2230_{M} arranged in a three-dimensional stacked structure, and the active layers 2230₁ to 2230_{M} may correspond to different wavelength bands.

For example, the active layers 2230₁ to 2230_{M} of each cell may be stacked one after the other on the substrate 2260. Among the active layers 2230₁ to 2230_{M}, a first active layer 2230₁ may correspond to an infrared band, a second active layer 2230₂ may correspond to a red light band, a third active layer 2230₃ may correspond to a green light band, a fourth active layer 2230₄ may correspond to a blue light band, and a fifth active layer 2230₅ may correspond to a near ultraviolet band. The stacked active layers may be separated from each other by a transparent separator layer between them. Each cell may include all of the first to fifth active layers 2230₁ to 2230₅, or only some of the first to fifth active layers 2230₁ to 2230₅, as necessary.

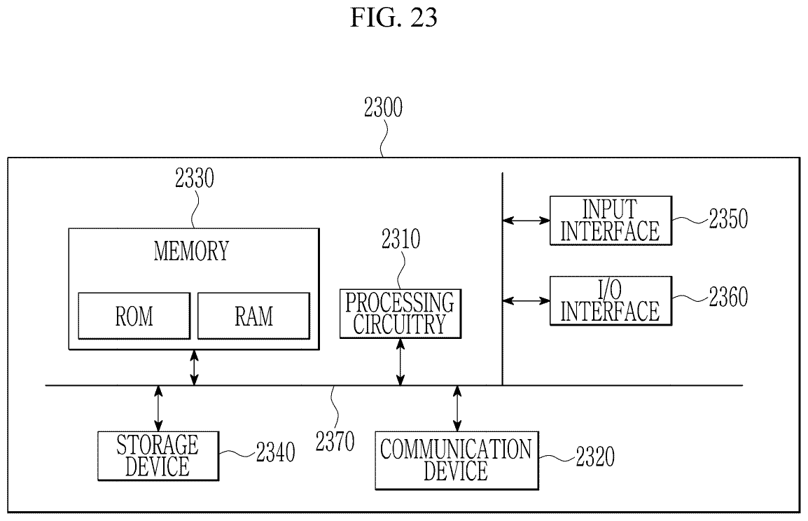

FIG. 23 is a block diagram of a computing device according to some example embodiments.

Referring to FIG. 23, a position estimation apparatus may include a computing device 2300 for executing a position estimation method. The computing device 2300 may include at least one of a processing circuitry 2310, a memory 2330, an input interface device 2350, an input/output interface device 2360, and a storage device 2340, which communicate with each other via a bus 2370. The input interface device 2350 may be configured to receive inputs. For example, the input interface device 2350 may be configured to receive inputs from a plurality of photoelectric devices (e.g., 210 of FIG. 2). The input/output interface device 2360 may be configured to receive and/or provide information, e.g., to a user. For example, the input/output interface device 2360 may be a speaker, a display, a touch pad, a button, a keyboard, a microphone, a USB port, etc. The computer device 2300 may further include a communication device 2320 coupled to a network. The communication device 2320 may be configured to transmit or receive wired signals or wireless signals.

The processing circuitry 2310 may be, for example, a central processing unit (CPU) or other semiconductor device that executes instructions stored in the memory 2330 or the storage device 2340; however, the example embodiments are not limited thereto. The memory 2330 and the storage device 2340 may include various forms of volatile or non-volatile storage media. For example, the memory 2330 may include a read only memory (ROM) and/or a random access memory (RAM). In some example embodiments, the memory 2330 may be located inside or outside of the processing circuitry 2310, and the memory 2330 may be coupled to the processing circuitry 2310 through various means already known in the art.

In some example embodiments, the position estimation method may be implemented as a computer-implemented method, or may be implemented as a non-transitory computer-readable medium on which computer-executable instructions are stored. In some example embodiments, the computer-readable instructions, when executed by the processing circuitry 2310, may perform the position estimation method.

Meanwhile, embodiments are not only implemented through the apparatus and/or method described so far, but may also be implemented through a program that realizes a function corresponding to the configuration of the embodiments or a recording medium on which the program is recorded, and such implementation can be easily implemented by a person skilled in the art of the present disclosure from the disclosure of the embodiments. Specifically, the method according to the embodiments (e.g., position estimation method) may be implemented in the form of a program instruction that can be executed through various computer means, and may be recorded on a computer-readable medium. The computer-readable medium may be a non-transitory storage medium including (e.g., storing) program instructions, data files, data structures, and the like singly or in combination. The computer-readable recording medium may include a hardware device configured to store and execute program instructions. For example, the computer-readable recording medium may include a magnetic medium such as a hard disk, a floppy disk, or a magnetic tape, an optical medium such as a CD-ROM or a DVD, or a magneto-optical medium such as a floptical disk, a ROM, a RAM, or a flash memory. The program instructions may include a machine language code created by a compiler, or a high-level language code that can be executed by a computer through an interpreter.

While the inventive concepts have been described in connection with what is presently considered to be practical embodiments, it is to be understood that the inventive concepts are not limited to the disclosed embodiments. On the contrary, it is intended to cover various modifications and equivalent arrangements included within the spirit and scope of the appended claims.

What is claimed is:

1. A position estimation apparatus comprising:
a filter configured to have an attenuation ratio that varies depending on a transmission point of an optical signal and to output a second optical signal by attenuating a first optical signal emitted from a light source according to the attenuation ratio;
a plurality of polarization filters configured to have different polarization directions, each of the plurality of polarization filters configured to output a corresponding third optical signal, of a plurality of third optical signals, by polarizing the second optical signal;
a plurality of photoelectric devices, each of the plurality of photoelectric devices configured to convert at least one of the plurality of third optical signals into a corresponding electrical signal of a plurality of electrical signals; and
a processing circuitry configured to estimate a position of the position estimation apparatus based on the plurality of electrical signals.

2. The position estimation apparatus of claim 1, further comprising:
a lens configured to focus the first optical signal and to transmit the first optical signal to the filter.

3. The position estimation apparatus of claim 1, wherein the filter is configured to have a radial gradient pattern and the attenuation ratio varies from a center of the filter to an edge of the filter.

4. The position estimation apparatus of claim 1, wherein the filter is configured such that the attenuation ratio that varies depending on the transmission point is based on the first optical signal being generated by polarizing light emitted from the light source using a rotating polarization filter.

5. The position estimation apparatus of claim 1, wherein the processing circuitry is configured to:
average the plurality of electrical signals to generate a plurality of first signals, respectively; and
estimate the position based on gains of the plurality of first signals.

6. The position estimation apparatus of claim 5, wherein the processing circuitry is configured to determine a peak-to-peak amplitude of each of the plurality of first signals to determine the gains of the plurality of first signals.

7. The position estimation apparatus of claim 5, further comprising:
a storage device configured to store an optical fingerprint map matching a signal characteristic of an electrical signal converted by each of the plurality of photoelectric devices to a plurality of points in a space in which the position estimation apparatus moves,
wherein the processing circuitry is configured to estimate the position based on a comparison of the optical fingerprint map and the gains of the plurality of first signals.

8. The position estimation apparatus of claim 7, wherein the processing circuitry is configured to estimate, as the position, a point having the signal characteristic matched to the gains of the plurality of first signals from among the plurality of points included in the optical fingerprint map.

9. The position estimation apparatus of claim 7, wherein the processing circuitry is configured to generate the optical fingerprint map based on information including a specification of the light source and a specification of the position estimation apparatus.

10. The position estimation apparatus of claim 9, wherein the specification of the light source includes a maximum output power of the light source and a light profile of the light source, and
wherein the specification of the position estimation apparatus includes the attenuation ratio of the filter.

11. The position estimation apparatus of claim 1, wherein the processing circuitry is configured to estimate an orientation angle of the position estimation apparatus based on the plurality of electrical signals.

12. The position estimation apparatus of claim 11, wherein the processing circuitry is configured to:
average the plurality of electrical signals to generate a plurality of first signals, respectively;
normalize the plurality of first signals to generate a plurality of second signals, respectively; and
estimate the orientation angle based on the plurality of second signals.

13. The position estimation apparatus of claim 12, wherein the processing circuitry is configured to normalize the plurality of first signals to have a same amplitude.

14. The position estimation apparatus of claim 1, wherein the processing circuitry is configured to:
average the plurality of electrical signals to generate a plurality of first signals, respectively;
invert the plurality of first signals to generate a plurality of second signals, respectively; and
recover transmit data for electrical signals, of the plurality of electrical signals, based on each second signal of the plurality of second signals.

15. The position estimation apparatus of claim 14, wherein the processing circuitry is configured to recover the transmit data by multiplying each second signal by the corresponding electrical signal.

16. A position estimation system comprising:
a light source configured to output light;
a rotating polarization filter configured to be rotate and to polarize the light output from the light source to output a first optical signal; and
a position estimation apparatus comprising
a filter configured to have an attenuation ratio that varies depending on a transmission point of an optical signal and to output a second optical signal by attenuating the first optical signal according to the attenuation ratio,
a plurality of polarization filters configured to have different polarization directions, each of the plurality of polarization filters configured to output a corresponding third optical signal, of a plurality of third optical signals, by polarizing the second optical signal,
a plurality of photoelectric devices, each of the plurality of photoelectric devices configured to convert at least one of the plurality of third optical signals into a corresponding electrical signal of a plurality of electrical signals, and
a processing circuitry configured to estimate a position of the position estimation apparatus based on the plurality of electrical signals.

17. The position estimation system of claim 16, wherein the position estimation apparatus further comprises a lens configured to focus the first optical signal and transmit the first optical signal to the filter.

18. The position estimation system of claim 16, wherein the processing circuitry is configured to estimate an orientation angle of the position estimation apparatus based on the plurality of electrical signals.

19. The position estimation system of claim 16, wherein the processing circuitry is configured to recover transmit data of the first optical signal based on the plurality of electrical signals.

20. A method of estimating a position of a moving apparatus, the method comprising:
outputting a second optical signal by attenuating, with a filter, a polarized first optical signal emitted from a light source, the filter having an attenuation ratio that varies depending on a transmission point of an optical signal;
outputting a plurality of third optical signals by polarizing the second optical signal using a plurality of polarization filters, the plurality of polarization filters each having different polarization directions;
converting the plurality of third optical signals into a plurality of electrical signals, respectively; and
estimating a positing of the moving apparatus based on the plurality of electrical signals.
